(19) United States
(12) Patent Application Publication
(10) Pub. No.: US 2016/0057177 A1
(43) Pub. Date: Feb. 25, 2016

(54) SERVER DEVICE, INFORMATION PROCESSING SYSTEM, AND NON-TRANSITORY COMPUTER READABLE MEDIUM

(71) Applicant: FUJI XEROX CO., LTD., Tokyo (JP)

(72) Inventors: Yasuhiro ITO, Kanagawa (JP); Toshiharu YOKOYAMA, Kanagawa (JP)

(73) Assignee: FUJI XEROX CO., LTD., Tokyo (JP)

(21) Appl. No.: 14/637,534

(22) Filed: Mar. 4, 2015

(30) Foreign Application Priority Data
Aug. 19, 2014 (JP) 2014-166588

(51) Int. Cl. H04L 29/06

(52) U.S. Cl. CPC H04L 65/1073

(57) ABSTRACT

A server device includes a registering unit, a providing unit, and a receiving unit. The registering unit registers a user or a guest as a user or a guest of the server device. The providing unit provides a first service to the user and a second service to the guest, the second service being more restricted than the first service. The receiving unit receives an instruction to register a guest from an administrator having authorization to manage the server device. If the administrator has authorization to manage a different server device, the registering unit registers a user registered in the different server device in the server device as a guest.

### CROSS-REFERENCE TO RELATED APPLICATIONS

This application is based on and claims priority under 35 USC 119 from Japanese Patent Application No. 2014-166588 filed Aug. 19, 2014.

### BACKGROUND

### Technical Field

The present invention relates to a server device, an information processing system, and a non-transitory computer readable medium.

### SUMMARY

According to an aspect of the invention, there is provided a server device including: a registering unit that registers a user or a guest as a user or a guest of the server device; a providing unit that provides a first service to the user and a second service to the guest, the second service being more restricted than the first service; and a receiving unit that receives an instruction to register a guest from an administrator having authorization to manage the server device. If the administrator has authorization to manage a different server device, the registering unit registers a user registered in the different server device in the server device as a guest.

### BRIEF DESCRIPTION OF THE DRAWINGS

An exemplary embodiment of the present invention will be described in detail based on the following figures, wherein:

FIG. 1 illustrates an example of the overall configuration of an information processing system according to an exemplary embodiment of the invention;

FIG. 2 illustrates an example of the configuration of a server device;

FIG. 3 illustrates an example of the configuration of a terminal device;

FIG. 4 illustrates an example of the configuration of an authentication device;

FIG. 5 illustrates an example of the configuration of a guiding device;

FIG. 6 illustrates an example of the functional configuration of the server device;

FIGS. 7A and 7B are sequence charts illustrating the flows of procedures taken in the information processing system;

FIG. 8 illustrates an example of an authentication table;

FIGS. 9A and 9B illustrate examples of a guiding table;

FIGS. 10A and 10B illustrate examples of a user table;

FIGS. 11A and 11B illustrate examples of a guest table;

FIGS. 12A and 12B illustrate an example of a guest table and an example of a guiding table, respectively, in a first modified example;

FIG. 13 is a sequence chart illustrating the flow of a procedure taken in an information processing system of the first modified example; and

FIG. 14 is a sequence chart illustrating the flow of a procedure taken in an information processing system of a third modified example.

### DETAILED DESCRIPTION

### 1. Exemplary Embodiment

### 1-1. Overall Configuration of Information Processing System

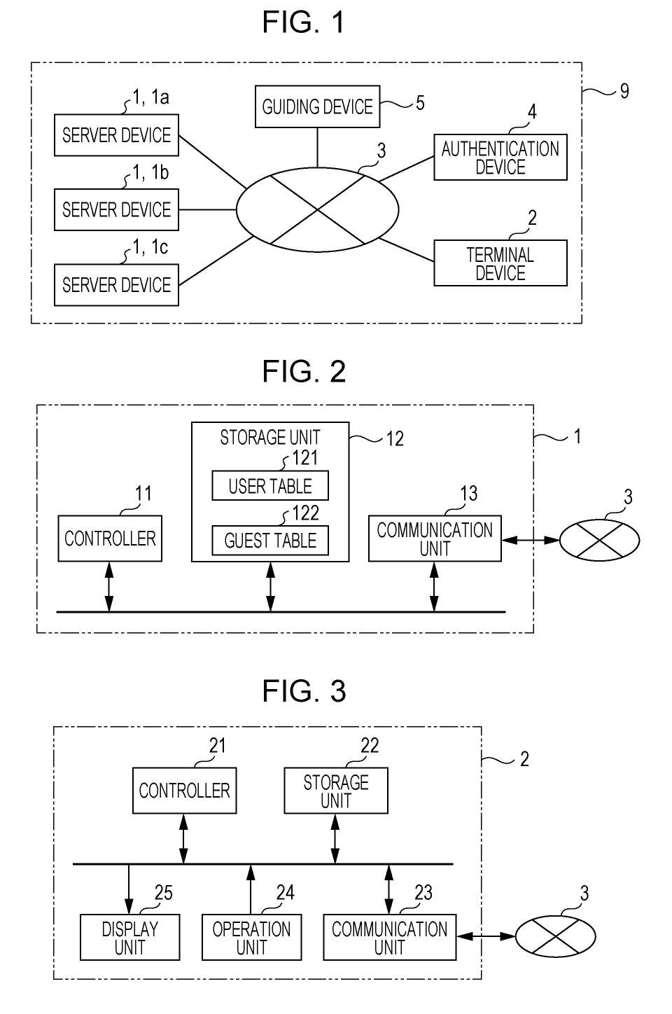

FIG. 1 illustrates an example of the overall configuration of an information processing system 9 according to an exemplary embodiment of the invention. As shown in FIG. 1, the information processing system 9 includes server devices 1a, 1b, and 1c (hereinafter will be referred to as the “server device 1” or the “server devices 1” unless these server devices 1a, 1b, and 1c are distinguished from each other), a terminal device 2, an authentication device 4, and a guiding device 5. The server devices 1, the terminal device 2, the authentication device 4, and the guiding device 5 are connected to each other via a communication network 3. The communication network 3 is a network, such as a local area network (LAN), a wide area network (WAN), the Internet, or a telephone line, through which computers perform data communication. Plural computers are connected to the communication network 3. The number of server devices 1 is not restricted to three and may be two or four or more. Each of the terminal devices 2, authentication devices 4, guiding devices 5, and communication networks 3 may be disposed in plural.

### 1-2. Configuration of Server Device

FIG. 2 illustrates an example of the configuration of the server device 1. A controller 11 is a control unit that controls the operations of the individual elements of the server device 1. The controller 11 includes a processor, such as a central processing unit (CPU), and storage units, such as a read only memory (ROM) and a random access memory (RAM), and executes programs stored in these storage units.

A communication unit 13 is a communication interface which is compliant with a communication protocol used in the communication network 3, and sends and receives information to and from the terminal device 2 via the communication network 3.

A storage unit 12 is a large-capacity storage unit, such as a hard disk, and stores a program read into the controller 11. The storage unit 12 may also include so-called removable disks, that is, detachable recording media.

The storage unit 12 also stores a user table 121 and a guest table 122. The user table 121 registers therein the user names of users permitted to use this server device 1 in association with authorizations given to the users in the server device 1. Authorization given to a user is a user attribute that determines operations to be performed by this user and services provided to this user in a server device in which this user is registered.

The guest table 122 records therein the device names of other server devices 1 in which users permitted to use this server device 1 as guests are registered. The server device 1 permits the users registered in other server devices 1 that can be identified by the device names recorded in the guest table 122 to use the server device 1 as guests.

The use of the server device 1 by a guest is different from that by a user registered in the server device 1 in that a guest is not individually distinguished from other guests. For example, even if a user registered in another server device 1 uses the server device 1 as a guest, a log concerning the use of the server device 1 is not identified by the individual user name of this guest. Instead, logs of the use of the server device 1 by individual guests are recorded together as a log concerning the use of the server device 1 without distinguishing these guests from each other, or they are recorded as the device names of other server devices 1 in which these guests are registered. A log concerning the use of the server device 1 by a guest may not have to be recorded.

### 1-3. Configuration of Terminal Device

FIG. 3 illustrates an example of the configuration of the terminal device 2. A controller 21 is a control unit that controls the operations of the individual elements of the terminal device 2. The controller 21 includes a processor, such as a CPU, and storage units, such as a ROM and a RAM, and executes programs stored in the storage units.

A storage unit 22 is a large-capacity storage unit, such as a flash memory, and stores therein a program read into the controller 21. The storage unit 22 may also include so-called removable disks, that is, detachable recording media.

A communication unit 23 is an interface that sends and receives information to and from the server device 1 and other devices via the communication network 3.

An operation unit 24 includes operators, such as a touch panel or buttons through which various instructions are given. The operation unit 24 receives an operation performed by a user and supplies a signal indicating the content of the operation to the controller 21. The operation unit 24 may include a transparent touch panel superposed on a surface of a display unit 25 on which images are displayed.

The display unit 25 is a display using, for example, a liquid crystal, and includes a screen that displays an image in response to an instruction from the controller 21.

### 1-4. Configuration of Authentication Device

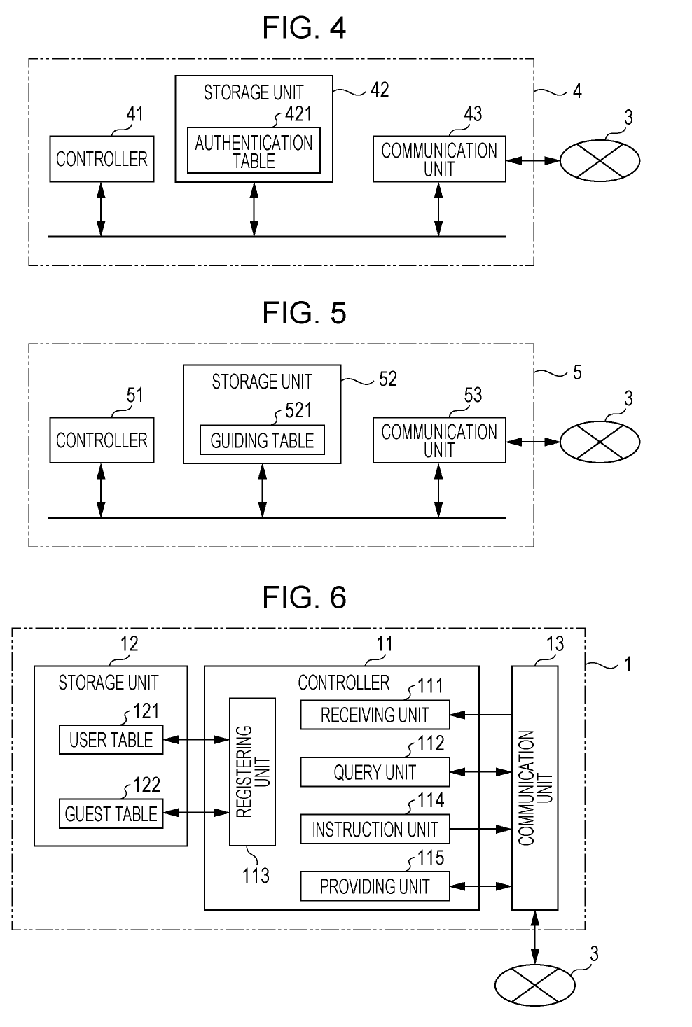

FIG. 4 illustrates an example of the configuration of the authentication device 4. A controller 41 is a control unit that controls the operations of the individual elements of the authentication device 4. The controller 41 includes a processor, such as a CPU, and storage units, such as a ROM and a RAM, and executes programs stored in the storage units.

A communication unit 43 is an interface that sends and receives information to and from the terminal device 2 and other devices via the communication network 3.

A storage unit 42 is a large-capacity storage unit, such as a hard disk, and stores therein a program read into the controller 41. The storage unit 42 may also include so-called removable disks, that is, detachable recording media.

The storage unit 42 includes an authentication table 421. The authentication table 421 is used for authenticating users registered in the server devices 1 in the information processing system 9. The authentication table 421 stores, for example, user names and passwords only known to users identified by these user names in association with each other.

### 1-5. Configuration of Guiding Device

FIG. 5 illustrates an example of the configuration of the guiding device 5. A controller 51 is a control unit that controls the operations of the individual elements of the guiding device 5. The controller 51 includes a processor, such as a CPU, and storage units, such as a ROM and a RAM, and executes programs stored in the storage units.

A communication unit 53 is an interface that sends and receives information to and from the terminal device 2 and other devices via the communication network 3.

A storage unit 52 is a large-capacity storage unit, such as a hard disk, and stores therein a program read into the controller 51. The storage unit 52 may also include so-called removable disks, that is, detachable recording media.

The storage unit 52 includes a guiding table 521. The guiding table 521 is used for guiding a user to a server device 1 that can be used by this user in the information processing system 9. That is, the guiding table 521 shows available server devices 1 for a user in the information processing system 9. The guiding table 521 stores, for example, a user name in association with a server device 1 in which the user identified by this user name is registered and/or a server device 1 that permits this user to use the server device 1 as a guest.

### 1-6. Functional Configuration of Server Device

FIG. 6 illustrates an example of the functional configuration of the server device 1. The controller 11 of the server device 1 functions as a receiving unit 111, a query unit 112, a registering unit 113, an instruction unit 114, and a providing unit 115 as a result of executing a program stored in the storage unit 12.

The receiving unit 111 receives an instruction to register a user registered in a different server device 1 in this subject server device 1 as a guest from the terminal device 2 via the communication network 3 and the communication unit 13. This instruction is provided as a result of an administrator having authorization to manage this subject server device 1 (hereinafter authorization to manage a server device 1 will be referred to as “management authorization”) operating the terminal device 2.

The query unit 112 queries the different server device 1 via the communication network 3 and the communication unit 13 as to whether or not the administrator provided the above-described instruction has management authorization of the different server device 1.

The registering unit 113 registers a user or a guest in the server device 1. If the administrator provided the above-described instruction has management authorization of the different server device 1, the registering unit 113 writes the device name (identification information) of the different server device 1 into the guest table 122 so as to register the user registered in the different server device 1 as a guest.

If the registering unit 113 has registered a user registered in the different server device 1 in the subject server device 1 as a guest, the instruction unit 114 instructs, via the communication network 3 and the communication unit 13, the guiding device 5 to store this user as a guest and the device name of the subject server device 1 in the guiding table 521 in association with each other.

The guiding device 5 guides a user associated with a device name in the guiding table 521 to this device name. That is, when the registering unit 113 has registered a user registered in a different server device 1 in the subject server device 1 as a guest, the instruction unit 114 instructs the guiding device 5 to guide this user to the subject server device 1.

The providing unit 115 provides a first service to a user and a second service to a guest. A user registered in a different server device 1 which is identified by a device name written into the guest table 122 by the registering unit 113 is registered in the subject server device 1 as a guest. Thus, the providing unit 115 provides the second service to this user.

The first service includes multiple services, such as reading of documents stored in the storage unit 12 and writing data into the documents.

The second service is a service which is more restricted than the first service, such as reading of documents stored in the storage unit 12 is permitted, but writing data into the documents is not permitted.

The providing unit 115 provides a user, as the first service, with log processing for storing a log concerning the use of the subject server device 1 by this user in the storage unit 12 by distinguishing this user from other users. The providing unit 115 also provides a guest, as the second service, with log processing for storing a log concerning the use of the subject server device 1 by this guest in the storage unit 12 without distinguishing this guest from other guests.

In the log processing provided as the second service, even if a user registered in a different server device 1 uses the subject server device 1 as a guest, a log concerning the use of the subject server device 1 by this user as a guest is stored without distinguishing this user from other users. Accordingly, such log processing is more restricted than that of the first service. Thus, computer resources consumed by log processing, such as the space of a storage medium used for storing log information and the processing time of a CPU when executing storing processing, of the second service is smaller than that of the first service. The load imposed on the server device 1 for providing the second service is also lower than that for the first service.

The first service and the second service are not restricted to the above-described services. The first and second services may include a video playback service. In this case, the maximum value of the bitrate of video that can be played back in the second service may be set to be lower than that in the first service. Concerning individual functions of video playback, there may be no difference between the first service and the second service as long as the second service is more restricted so that the load of the second service will be, as a whole, lower than that of the first service, that is, as long as the load imposed by providing the second service will be, as a whole, lower than that by providing the first service.

### 1-7. Operation of Information Processing System

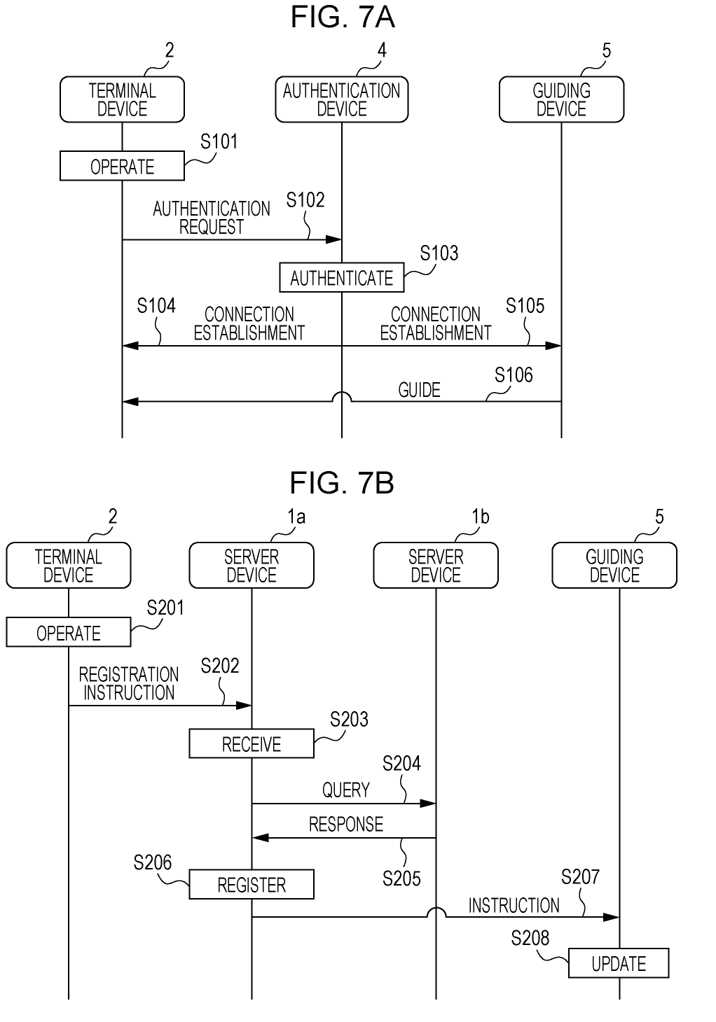

FIGS. 7A and 7B are sequence charts illustrating the flows of procedures taken in the information processing system 9. FIG. 7A illustrates the flow of a procedure for guiding the terminal device 2 by the guiding device 5. FIG. 7B illustrates the flow of a procedure for registering users of the server device 1b in the server device 1a as guests.

Reference will be first given to FIG. 7A. In step S101, the terminal device 2 receives an operation performed by a user for requesting the authentication device 4 to conduct authentication for using the information processing system 9. The user operates the operation unit 24 to input the user name and password. In step S102, the terminal device 2 sends an authentication request including the user name and password input by the user to the authentication device 4 via the communication network 3.

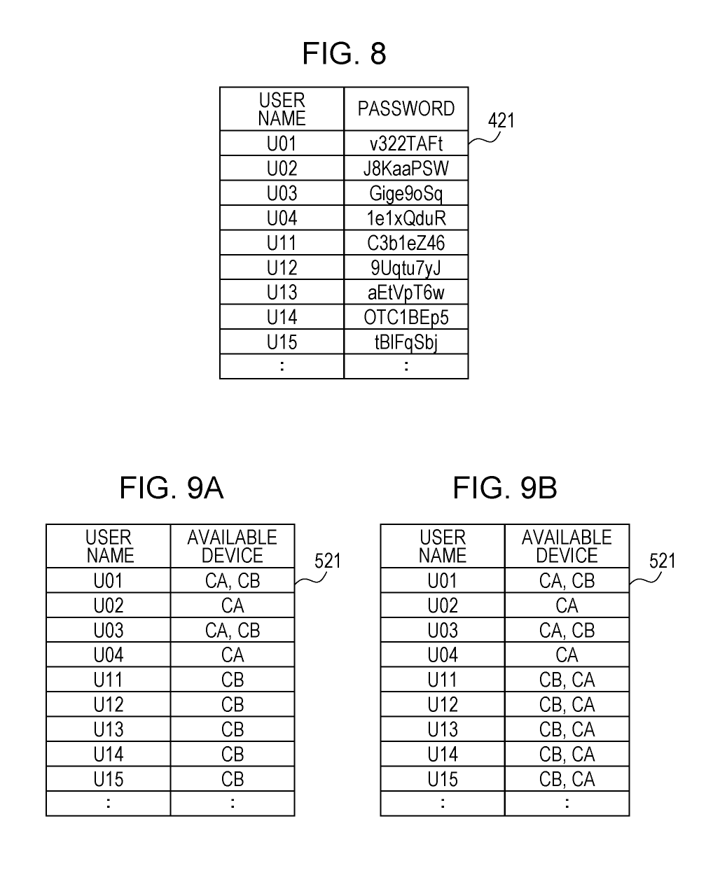

FIG. 8 illustrates an example of the authentication table 421. If the authentication table 421 shown in FIG. 8 is stored in the storage unit 42 of the authentication device 4, upon receiving the authentication request, in step S103, the authentication device 4 refers to this authentication table 421 and determines whether or not a set of the user name and password included in the authentication request are included in the authentication table 421, thereby conducting authentication of the user.

For example, if the user operates the terminal device 2 to input the user name “U01” and the password “v322TAFt” and the terminal device 2 sends an authentication request including this user name and this password to the authentication device 4, the authentication device 4 finds a set of this user name and this password in the authentication table 421. Thus, authentication succeeds. If authentication succeeds, in step S104, the authentication device 4 informs the terminal device 2 that connection has been established (connection establishment). Then, in step S105, the authentication device 4 also informs the guiding device 5 of connection establishment.

FIGS. 9A and 9B illustrate examples of the guiding table 521. Upon receiving information indicating connection establishment, in step S106, the guiding device 5 reads, from the guiding table 521, a device name associated with the user name of the user requested authentication, and informs the terminal device 2 that the server device 1 identified by the read device name is available.

For example, if the guiding table 521 shown in FIG. 9A is stored in the storage unit 52 of the guiding device 5, the device names of available server devices 1 that can be used by the user of the user name “U01” are “CA, CB”. Accordingly, the guiding device 5 informs the terminal device 2 of the device names “CA” and “CB”. That is, the guiding device 5 informs the user of the terminal device 2 that the server device 1a indicated by the device name “CA” and the server device 1b indicated by the device name “CB” are available. In this case, the guiding device 5 may supply the user of the terminal device 2 with a temporal password for connecting to each of the available server devices 1. Then, the terminal device 2 is able to connect to each of the available server devices 1.

In this guiding table 521, an authenticated user is associated with the device name of an available server device 1 without specifying whether the authenticated user can use this server device 1 as a user or as a guest. However, the guiding table 521 may store the association between a user and the device name of an available server device 1 in a different manner. In the guiding table 521, a user authenticated by the authentication device 4 may be associated with the device name of an available server device 1 by specifying whether the authenticated user can use this server device 1 as a user or as a guest. That is, the device name of a server device 1 in which an authenticated user is registered may be distinguished from the device name of a server device 1 in which the authenticated user is registered as a guest. In this case, the guiding device 5 may show the user of the terminal device 2 in which server device 1 the user is registered as a user and in which server device 1 the user is registered as a guest.

Then, as shown in FIG. 7B, in step S201, the terminal device 2 receives an instruction to register users registered in the server device 1b in the server device 1a as guests. Upon receiving information about the available server devices 1 from the guiding device 5, the user selects the server device 1a indicated by the device name “CA” among the available server devices 1, and operates the operation unit 24 to instruct the server device 1a to register the users of the server device 1b indicated by the device name “CB” as guests. Then, upon receiving this registration instruction, in step S202, the terminal device 2 sends this registration instruction to register the users of the server device 1b as guests to the server device 1a.

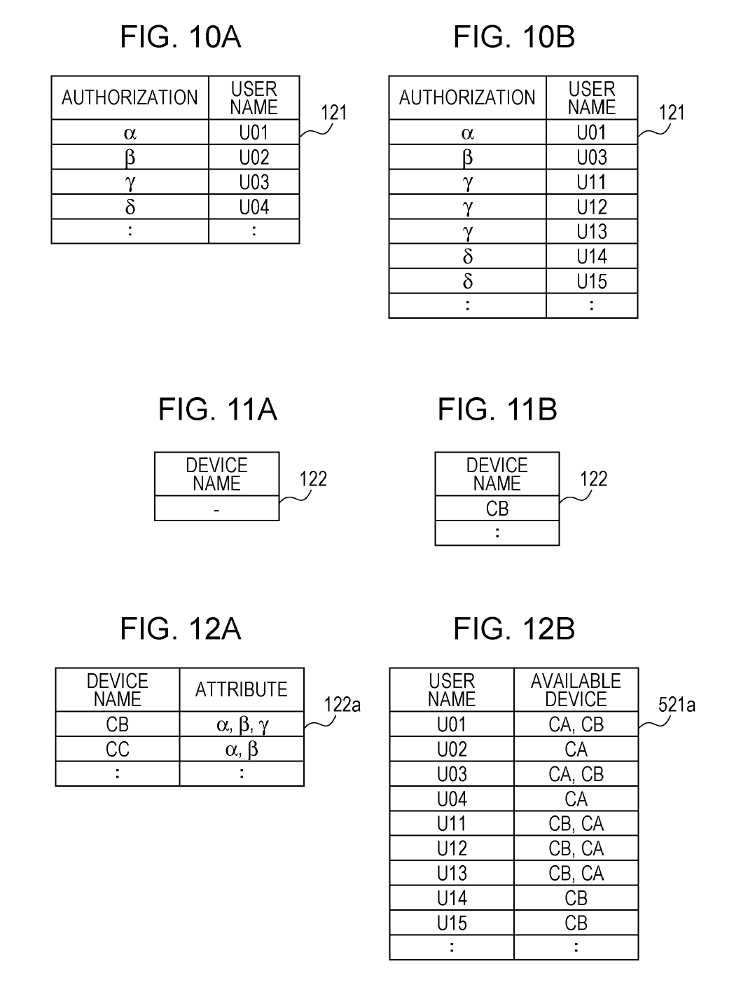

In step S203, the server device 1a receives this registration instruction from the user indicated by the user name “U01”. FIGS. 10A and 10B illustrate examples of the user table 121. In the server device 1a, the user table 121 shown in FIG. 10A is stored in the storage unit 12, and in the server 1b, the user table 121 shown in FIG. 10B is stored in the storage unit 12. User authorizations are classified into four types. “Authorization α” is an authorization to manage two or more server devices 1 (management authorization). “Authorization β” is an authorization to manage one server device 1 (management authorization).

“Authorization γ” and “authorization δ” do not have management authorization of any server device 1 but have authorization to receive services provided by server devices 1. There are differences in the services that can be received from the server devices 1 between “authorization γ” and “authorization δ”.

The server device 1a refers to the user table 121 and determines whether or not the user sent the registration instruction has management authorization of the server device 1a. The user table 121 shown in FIG. 10A indicates that the authorization in association with the user name “U01” is “α”, and thus, the server device 1a determines that this user has management authorization of the server device 1a (that is, the user is the administrator of the server device 1a). The administrator of the server device 1 is required to have management authorization of the server device 1, but may not have to be registered in the server device 1 as a user.

If the server device 1a determines that the user sent the registration instruction is the administrator of the server device 1a, in step S204, the server device 1a queries the server device 1b as to whether this administrator has management authorization of the server device 1b.

On the other hand, if the server device 1a determines that the user sent the registration instruction is not the administrator of the server device 1a, it may ignore this registration instruction. In this case, the server device 1a may send information that the received registration instruction will be ignored since the user sent the registration instruction is not the administrator of the server device 1a that has been instructed to register the users of the server device 1b to the terminal device 2.

Upon receiving the query from the server device 1a, in step S205, the server device 1b refers to the user table 121 stored in the storage unit 12 and determines whether or not the administrator of the server device 1a has management authorization of the server device 1b. The server device 1b then sends a response in accordance with the determination result. The user table 121 shown in FIG. 10B indicates that the authorization associated with the user name “U01” is “a”, and thus, the server device 1b determines that the administrator of the server device 1a also has management authorization of the server device 1b, and sends a response indicating this determination result to the server device 1a.

If the server device 1b determines that the administrator of the server device 1a does not have management authorization of the server device 1b, it sends a response indicating this determination result to the server device 1a. In this case, the server device 1a may ignore the registration instruction, and may send information that the received registration instruction will be ignored since the user sent the registration instruction is not the administrator of the server device 1b to the terminal device 2.

Upon receiving a response indicating that the administrator of the server device 1a has management authorization of the server device 1b, in step S206, the server device 1a writes the device name of the server device 1b into the guest table 122, thereby registering users of the server device 1b in the server device 1a as guests.

FIGS. 11A and 11B illustrate examples of the guest table 122. Before step S206, as shown in FIG. 11A, in the guest table 122 stored in the storage unit 12 of the server device 1a, there is no device name of another server device 1 in which a user permitted to use the server device 1a as a guest is registered. That is, in this case, the server device 1a does not allow any users registered in the other server devices 1 to use the server device 1a as a guest.

As a result of executing step S206, as shown in FIG. 11B, “CB” is written as the device name into the guest table 122 stored in the storage unit 12 of the server device 1a. Then, the server device 1a allows the users registered in the server device 1b having the device name “CB” to use the server device 1a as guests.

Then, in step S207, the server device 1a sends, via the communication network 3 and the communication unit 13, the guiding device 5 an instruction to store the users registered as guests and the device name of the server device 1a in the guiding table 521 in association with each other. Upon receiving this instruction, in step S208, the guiding device 5 updates the guiding table 521 accordingly.

For example, if the guiding table 521 shown in FIG. 9A is stored in the storage unit 52 of the guiding device 5, the guiding device 5 adds “CA”, which is the device name of the server device 1a, to the available server devices 1 associated with the users registered in the server device 1b, that is, to the available server devices 1 associated with the users in which “CB”, which is the device name of the server device 1b, is indicated. As a result, the guiding table 521 is updated to the guiding table 521 shown in FIG. 9B.

That is, for all the users of the user names “U11”, “U12”, “U13”, “U14”, and “U15”, the device name “CB” is indicated as the available server device 1. After the server device 1a has registered the device name of the server device 1b in the guest table 122 and the guiding device 5 has updated the guiding table 521, the device name “CA” is added as another available server device 1.

As described above, when a subject server device 1 receives, from the administrator of the subject server device 1, an instruction to register users of a different server device 1 in the subject server device 1 as guests, it registers these users in the subject server device 1 if the administrator is also the administrator of the different server device 1. Thus, it is possible for an administrator managing two server devices to register users which have already been registered in one server device in the other server device together.

### 2. Modified Examples

The above-described exemplary embodiment may be modified in the following manner, and the following modified examples may be combined.

### 2-1. First Modified Example

In the above-described exemplary embodiment, if the administrator of a server device 1 sent an instruction to register users of a different server device 1 as guests also has management authorization of the different server device 1, the registering unit 113, which is implemented by the controller 11 of the server device 1, registers these users as guests. However, the registering unit 113 may not have to register all users registered in the different server device 1 as guests. Instead, the registering unit 113 may register only users having a predetermined attribute as guests among the users registered in the different server device 1. This will be discussed below as a first modified example.

FIGS. 12A and 12B illustrate an example of a guest table 122a and an example of a guiding table 521a, respectively, in the first modified example. In the guest table 122a shown in FIG. 12A, not only the device names of different server devices 1 in which users registered in a subject server device 1 as guests are registered as users, but also the attributes of these users in the different server devices 1 are indicated.

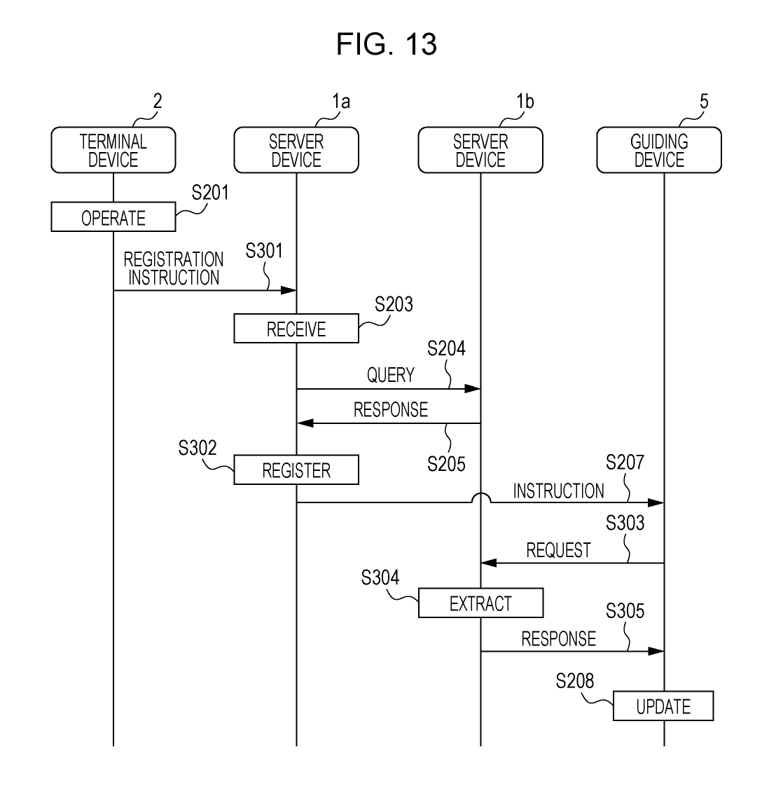

FIG. 13 is a sequence chart illustrating the flow of a procedure taken in an information processing system of the first modified example. In FIG. 13, the same operations as those of FIG. 7B are indicated by like step numbers, and an explanation thereof will thus be omitted.

In the first modified example, step S301 is executed instead of step S202. After receiving an operation performed in step S201, in step S301, the terminal device 2 sends the server device 1a a registration instruction to extract users having a predetermined attribute among the users of the server device 1b and to register these extracted users as guests.

Then, if, in step S205, the server device 1b sends a response indicating that the administrator of the server device 1a has management authorization of the server device 1b, in step S302, the server device 1a receives this response and then writes the device name of the server device 1b and the above-described attribute into the guest table 122a in association with each other. Then, among the users registered in the server device 1b, the server device 1a registers the users having the predetermined attribute as guests of the server device 1a.

For example, in step S302, the attributes “α, β, γ” are written into the guest table 122a in association with the device name “CB”, as shown in FIG. 12A. This means that, among the users of the server device 1b, only users having one of the authorizations α, β, and γ are registered in the server device 1a as guests.

After registering the users having one of the authorizations α, β, and γ in the server device 1a as guests, the server device 1a sends, in step S207, via the communication network 3 and the communication unit 13, the guiding device 5 an instruction to store the users registered as guests and the device name of the server device 1a in the guiding table 521 in association with each other. Upon receiving this instruction, in step S303, the guiding device 5 sends a request to extract the users having one of the above-described attributes to the server device 1b.

In step S304, in response to this request, the server device 1b refers to the user table 121 and extracts users having one of the above-described attributes, that is, having one of the authorizations α, β, and γ, among the users registered in the server device 1b. Then, in step S305, the server device 1b sends a response including the extracted users to the guiding device 5. In step S208, the guiding device 5 updates the guiding table 521 in accordance with the response.

For example, in the storage unit 12 of the server device 1b, the user table 121 is stored, as shown in FIG. 10B. Among the users indicated by the user names in this user table 121, a user having the authorization α is “U01”, a user having the authorization β is “U03”, and users having the authorization γ are “U11”, “U12”, and “U13”. The authorization given to the users identified by “U14” and “U15” is δ. Accordingly, among the users registered in the server device 1b, the server device 1b extracts “U01”, “U03”, “U11”, “U12”, and “U13” as the user names of the users having one of the authorizations α, β, and γ, and excludes “U14” and “U15”.

As a result, the guiding device 5 adds “CA”, which is the device name of the server device 1a, to the available devices associated with the extracted users in the guiding table 521. Thus, the guiding table 521 shown in FIG. 9A is updated to the guiding table 521a shown in FIG. 12B. In the guiding table 521a shown in FIG. 12B, “CA” is added to the available devices associated with “U11”, “U12”, and “U13”, but “CA” is not added to the available devices associated with “U14” and “U15”.

As discussed above, in the information processing system of the first modified example, a determination as to whether a user of a different server device 1 will be registered in a subject server device 1 is made in accordance with the attribute of the user set in the different server device 1.

### 2-2. Second Modified Example

In the above-described exemplary embodiment, the registering unit 113 registers, as guests, users which have already been registered in a different server device 1 when the receiving unit 111 receives a registration instruction. However, the registering unit 113 may register, as guests, users which are registered in a different server 1 after the receiving unit 111 has received a registration instruction.

Accordingly, instead of storing the device name of a different server 1 in which users are registered, the subject server device 1 may store identification information of the users registered in the different server device 1 in the subject server device 1, and may register these users in the subject server device 1 as guests.

In this case, the controller 11 of the subject server device 1 stores a received registration instruction in the storage unit 12. Upon detecting that a new user is registered in a different server device 1 indicated by the received registration instruction, the controller 11 refers to this instruction and registers the new user in the subject server device 1 indicated by this instruction as a guest. This makes it possible to apply a registration instruction which has already been received to a user which is newly registered in the different server device 1.

If, as in the exemplary embodiment, by storing the device name of a different server device 1 in which users are registered, a subject server device 1 registers the users of the different server device 1 as guests of the subject server device 1, when a new user is registered in the different server device 1, this user is automatically registered in the subject server device 1 as a quest without performing any processing.

### 2-3. Third Modified Example

In the above-described exemplary embodiment, the maximum value of the number of users registered in a server device 1 is not set. However, the maximum value may be set for the number of users. In this case, a server device 1 may store the maximum value of the number of users that can be registered in the server device 1 in the storage unit 12, and the controller 11 of the server device 1 may read and obtain the maximum value of the number of users from the storage unit 12. The controller 11 is an example of an obtaining unit that obtains the maximum value of the number of users that can be registered in a subject server device 1.

It is assumed that the receiving unit 111 has received a registration instruction to register a user from the administrator of the subject server device 1 and that the registering unit 113 has registered the user in accordance with this registration instruction. In this case, if the number of users to be registered in the subject server device 1 exceeds the maximum value obtained by the controller 11, the registering unit 113 may register this user in the server device 1 as a guest.

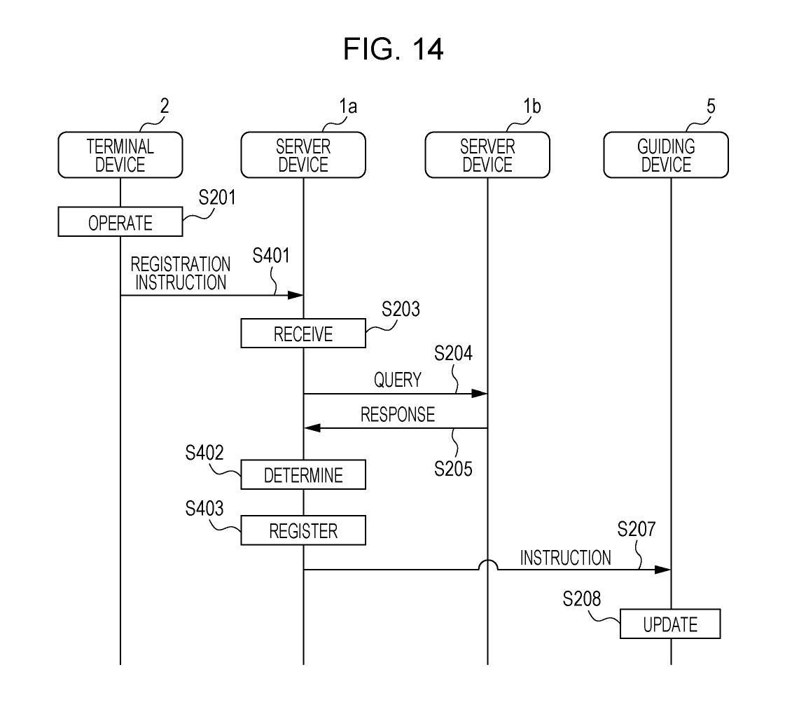

FIG. 14 is a sequence chart illustrating the flow of a procedure taken in an information processing system of the third modified example. In FIG. 14, the same operations as those of FIG. 7B are indicated by like step numbers, and an explanation thereof will thus be omitted.

In the third modified example, step S401 is executed instead of step S202. More specifically, after receiving an operation performed in step S201, in step S401, the terminal device 2 sends the server device 1a a registration instruction to register users of the server device 1b in the server device 1a as users.

Then, in step S205, the server device 1b sends a response indicating that the administrator of the server device 1a has management authorization of the server device 1b. Upon receiving this response, in step S402, the server device 1a reads the maximum value stored in the storage unit 12 of the server device 1a and also specifies the number of users registered in the server device 1a by referring to the user table 121. Then, the server device 1a obtains the number of users registered in the server device 1b, and determines whether or not the total number of users registered in the two server devices 1a and 1b exceeds the read maximum value. To obtain the number of users registered in the server device 1b, the server device 1a may query the server device 1b as to the number of users registered in the server device 1b. Alternatively, the server device 1a may ask the server device 1b about the number of users registered in the server device 1b in the query made in step S204, and may obtain the number of users from the response received in step S205.

In step S403, the server device 1a performs registration processing in accordance with the determination result of step S402. For example, if it is determined in step S402 that the total number of users registered in the server devices 1a and 1b exceeds the maximum value, the server device 1a may register the users of the server device 1b in the server device 1a as guests instead of users. In this case, the server device 1a may inform the terminal device 2 that it is not possible to register the users of the server device 1b as users and may request the terminal device 2 to give a permission to register the users as guests. Alternatively, simply, the server device 1a may not register the users of the server device 1b.

If it is determined in step S402 that the total number of users registered in the server devices 1a and 1b does not exceed the maximum value, the server device 1a may register the users of the server device 1b in the server device 1a as users, as instructed.

As discussed above, in the information processing system of the third modified example, the number of users registered in a server device 1 does not exceed a predetermined maximum value.

### 2-4. Fourth Modified Example

In the above-described first modified example, the registering unit 113 registers, among users registered in a different server device 1, users having a predetermined attribute, that is, users having a predetermined authorization in the different server device 1, as guests. The attribute is not restricted to an attribute set in the different server device 1. For example, if a user registered in a different server device 1 has already been registered in a subject server device 1 as a user, the registering unit 113 may not register this user as a guest.

More specifically, upon receiving a registration instruction to register users of the server device 1b as guests from a user, the server device 1a may obtain a list of the users from the server device 1b after checking that the user sent this registration instruction is the administrator of both of the server devices 1a and 1b. Then, the server device 1a may verify the obtained list of the users registered in the server device 1b against a list of users registered in the server device 1a, and may not register users which have already been registered both in the server devices 1a and 1b as guests.

With this arrangement, the status of a user of the server device 1b in the server device 1a is restricted to only one of a user or a guest. Accordingly, when a user of the server device 1b uses the server device 1a, it is not necessary to determine whether this user will use the server device 1a as a user or as a guest.

### 2-5. Fifth Modified Example

The above-described attribute is not restricted to authorization set in a different server device 1 in which a user is registered, but may be the status of this user, such as the user is on vacation or the user is on leave of absence.

More specifically, upon receiving a registration instruction to register users registered in the server device 1b as guests from a user, the server device 1a may obtain a list of the statuses of the users from the server device 1b after checking that the user sent this registration instruction is the administrator of both of the server devices 1a and 1b. Then, the server device 1a may register users only in predetermined statuses (for example, statuses other than being on leave of absence) as guests of the server device 1a.

### 2-6. Sixth Modified Example

In the above-described exemplary embodiment, the query unit 112 queries a different server device 1 as to whether the administrator of a subject server device 1 sent a registration instruction to register guests has management authorization of the different server device 1. However, if the subject server device 1 is able to determine whether or not the administrator of the subject server device 1 also has management authorization of the different server device 1, the query unit 112 does not have to make a query. In this case, the controller 11 may not have to have the function as the query unit 112.

If a user does not have management authorization of one of a subject server device 1 in which the user will be registered as a guest and a different server device 1 in which the user is registered as a user, the terminal device 2 may prevent this user from sending an instruction to register users of the different server device 1 in the subject server device 1 as guests. In this case, for example, the guiding device 5 may store in the guiding table 521, not only available devices, but also authorization of each user in each of the server devices 1, and the terminal device 2 may obtain authorization of the operator of the terminal device 2 in each of the server devices 1 from the guiding device 5.

### 2-7. Seventh Modified Example

A program executed by the controller 11 of the server device 1 may be provided after being stored in a computer readable storage medium, for example, a magnetic recording medium, such as magnetic tape or a magnetic disk, an optical recording medium, such as an optical disc, a magneto-optical recording medium, or a semiconductor memory. Alternatively, the program may be downloaded via a network, such as the Internet. As the control unit, various devices other than the CPU of the controller 11 may be used, for example, a dedicated processor may be used.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A server device comprising:
a registering unit that registers a user or a guest as a user or a guest of the server device;
a providing unit that provides a first service to the user and a second service to the guest, the second service being more restricted than the first service; and
a receiving unit that receives an instruction to register a guest from an administrator having authorization to manage the server device,
wherein, if the administrator has authorization to manage a different server device, the registering unit registers a user registered in the different server device in the server device as a guest.

2. The server device according to claim 1, wherein the first service provided by the providing unit includes a service in which a log concerning the use of the server device by the user is stored by distinguishing the user from other users, and the second service provided by the providing unit includes a service in which a log concerning the use of the server device by the guest is stored without distinguishing the guest from other guests registered in the server device.

3. The server device according to claim 1, wherein:
the registering unit stores identification information of the different server device so as to register a user registered in the different server device as the guest; and
the providing unit provides the second service to a user registered in the different server device identified by the identification information stored by the registering unit.

4. The server device according to claim 1, further comprising:
a query unit that queries the different server device as to whether or not the administrator that has provided the instruction has authorization to manage the different server device,
wherein, upon receiving, from the different server device in response to the query, a response indicating that the administrator has authorization to manage the different server device, the registering unit registers a user registered in the different server device as the guest.

5. The server device according to claim 1, wherein, among users registered in the different server device, the registering unit registers a user having a certain attribute determined in the different server device as the guest.

6. The server device according to claim 1, wherein the registering unit registers, as the guest, a user which is registered in the different server device after the receiving unit has received the instruction.

7. The server device according to claim 1, further comprising:
an obtaining unit that obtains a maximum value of the number of users to be registered in the server device,
wherein, assuming that the receiving unit has received an instruction to register a user from the administrator of the server device and that the registering unit has registered the user in accordance with the instruction, if the number of users to be registered in the server device exceeds the maximum value obtained by the obtaining unit, the registering unit registers the user as a guest of the server device.

8. An information processing system comprising:
a plurality of server devices; and
a guiding device that guides a user registered in one of the plurality of server devices to a server device of the plurality of server devices in which the user is registered as a user or a guest,
each of the plurality of server devices including
a registering unit that registers a user or a guest as a user or a guest of the server device,
a providing unit that provides a first service to the user and a second service to the guest, the second service being more restricted than the first service,
a receiving unit that receives an instruction to register a guest from an administrator having authorization to manage the server device, and
an instruction unit that instructs, if the registering unit registers a user registered in a different server device as the guest, the guiding device to guide the user to the server device,
wherein, if the administrator has authorization to manage a different server device, the registering unit registers a user registered in the different server device in the server device as a guest.

9. A non-transitory computer readable medium storing a program causing a computer of a server device to execute a process, the process comprising:
registering a user or a guest as a user or a guest of the server device;
providing a first service to the user and a second service to the guest, the second service being more restricted than the first service; and
receiving an instruction to register a guest from an administrator having authorization to manage the server device,
wherein, if the administrator has authorization to manage a different server device, a user registered in the different server device is registered in the server device as a guest.
